(19) United States
(12) Patent Application Publication
(10) Pub. No.: US 2012/0000713 A1
(43) Pub. Date: Jan. 5, 2012

(54) MARINE ELECTRONICS WITH LOAD CELL INTERFACE

(76) Inventor: KEITH TABOADA, Brielle, NJ (US)

(21) Appl. No.: 12/830,378

(22) Filed: Jul. 5, 2010

(51) Int. Cl. G01G 19/60

(52) U.S. Cl. 177/1; 177/245

(57) ABSTRACT

An on-vessel weight system and method for operating the same is provided. The on-vessel weight system is configured for determining a weight of a fish on board a recreational fishing vessel, but also may be adapted to be used off the fishing vessel. In one embodiment, an on-vessel weight system includes marine electronic instrument and a load cell having a communication feature operable to provide a signal indicative of a weight measured by the load cell to the marine electronic instrument.

### BACKGROUND OF THE INVENTION

1. Field of the Invention

Embodiments of the invention generally relate to marine electronics for sportfishing use.

2. Background

Sportfisherman often weigh their catch. Typically, weighing of the catch is done ashore due to the limited amount of space within the vessel which makes it undesirable to install a permanent scale. Moreover, scales installed on a vessel would be difficult to certify, as it would be a significant task to remove the scale to send the scale out for certification, then reinstalling the scale once certified. A number of portable scales are available for use on sportfishing boats. These portable scales are generally hand held, and have a limited predefined range. Thus, both large and small fish cannot normally be weighed with a single portable scale. Moreover, commercially available portable sportfishing scales are not certifiable.

Therefore, there is a need for an improved scale for use on sportfishing vessels.

### SUMMARY OF THE INVENTION

An on-vessel weight system is provided for determining a weight of a fish on board a recreational fishing vessel. The on-vessel weight system may also be adapted to used off the fishing vessel. In one embodiment, an on-vessel weight system includes marine electronic instrument and a load cell having a communication feature operable to provide a signal indicative of a weight measured by the load cell to the marine electronic instrument.

In another embodiment, an on-vessel weight system for use in a recreational fishing vessel includes a marine electronic instrument and a portable load cell. The marine electronic instrument is mountable to the recreational fishing vessel and has a communication feature. The marine electronic instrument is selected from, and/or is communication with an instrument is selected from, the group consisting of a depth sounder, fish finder, loran, global positioning system (GPS), chart plotter, radar and combinations thereof. The portable load cell includes a body, a communication feature, a power source and a switch. The communication feature is operable to provide a signal indicative of a weight suspended from the load cell to the marine electronic instrument. The body has at least one mounting feature and a load attaching feature, the at least one mounting feature suitable for suspending the body from an object. The switch is coupled to the body and operably couples the power source to the communication feature.

In another embodiment, a method for recording weight of a fish includes, on a marine electronic instrument, storing to memory weigh information in response to receiving a signal indicative of a weight of a fish suspended from a load cell, wherein the marine electronic instrument is or is in communication with at least one of a depth sounder, fish finder, loran, global positioning system (GPS), chart plotter or radar.

### BRIEF DESCRIPTION OF THE DRAWINGS

The teachings of the present invention can be readily understood by considering the following detailed description in conjunction with the accompanying drawings, in which:

FIG. 1 a schematic representation of a fishing vessel having an on-vessel weigh system; and

FIG. 2 is schematic representation of the on-vessel weigh system of FIG. 1.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally provide an on-vessel weight system and method for operating the same. The on-vessel weight system is configured for determining a weight of a fish on board a recreational fishing vessel, but also may be adapted to be used off the fishing vessel. Advantageously, the on-vessel weight system interfaces and/or includes marine helm electronics, which allows recordation of fish weight without need for additional equipment cluttering the helm area or additional equipment which may become a tripping hazard. Additionally, the on-vessel weight system allows certification of on-vessel weight system without removing the marine electronics from the vessel.

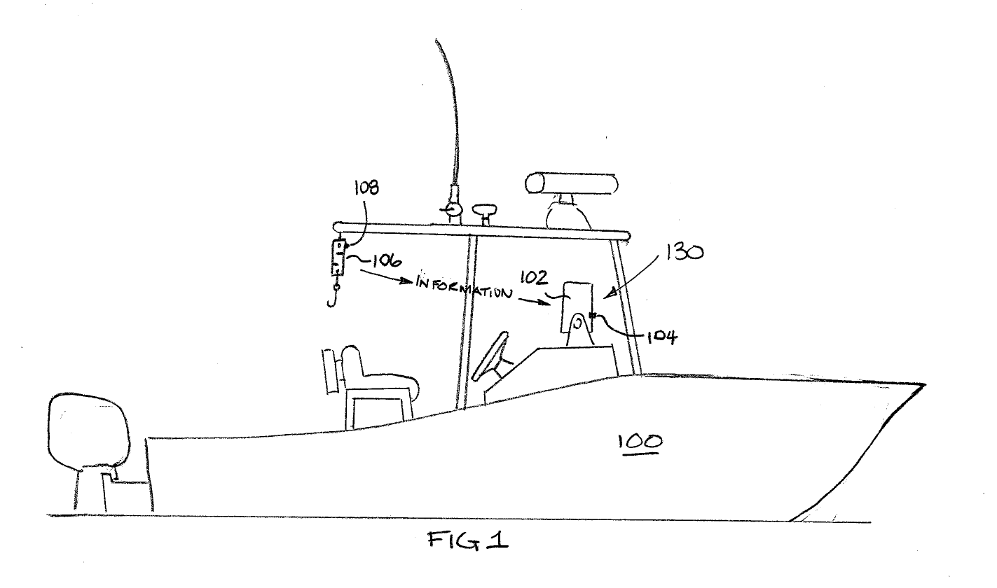

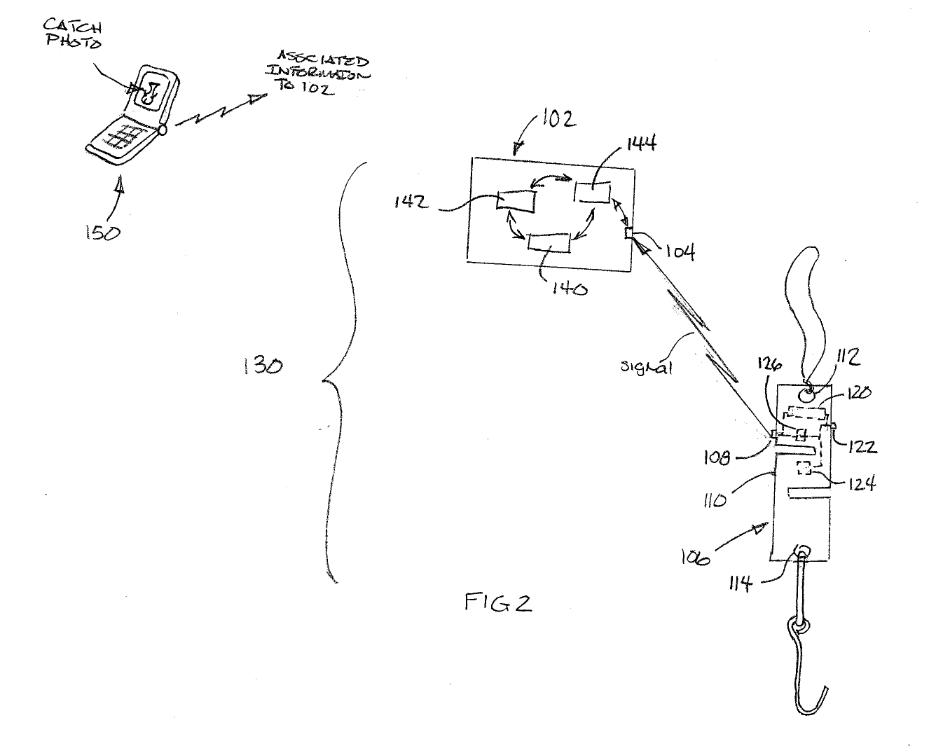

FIG. 1 is a schematic representation of a fishing vessel 100 having an on-vessel weigh system 130. FIG. 2 is a schematic representation of the on-vessel weigh system 130 of FIG. 1. Referring to both FIGS. 1-2, the on-vessel weigh system 130 includes a marine electronic instrument 102 and a suspendable load cell 106. The marine electronic instrument 102 may be mounted to the vessel 100, or hand-held. The marine electronic instrument 102 includes, or is interfaced with at least one of a depth sounder, fish finder, loran, global positioning system (GPS), chart plotter or radar. The marine electronic instrument 102 additionally has a communication feature 104 that marine electronic instrument 102 to receive information from the load cell 106 positioned on the vessel 100 remotely from the marine electronic instrument 102 via a communication feature 108 coupled to the load cell 106. The marine electronic instrument 102 may be hand held and/or mountable to the vessel 100, as known in the marine trades.

The marine electronic instrument 102 includes memory 140, processor 142 and support circuits 144. The processor 142 facilitates the function of the marine electronic instrument 102. The memory 140, or computer-readable medium, of the processor 142 may be one or more of readily available memory such as random access memory (RAM), read only memory (ROM), floppy disk, hard disk, or any other form of digital storage, local or remote. The support circuits 144 are coupled to the processor 142 for supporting the processor in a conventional manner. These circuits include cache, power supplies, clock circuits, input/output circuitry and subsystems, and the like.

The communication feature 104 of the marine electronic instrument 102 and the communication feature 108 of the load cell 106 may communicate via a cable suitable for marine use, or wirelessly. Suitable wireless communication protocols may include radio frequency communication protocol, microwave communication protocol, infrared (IR) communication protocol, for example via protocols adapted by the Infrared Data Association (IrDA), standard IEEE 802.11 protocol, Bluetooth protocol or some other suitable wireless data communications protocol. The communication feature 104 or other communication feature of the marine electronic instrument 102 may also be used to communicate with another electronic device other than the load cell 106. For example, the communication feature 104 may be utilized to communicate with other marine electronic instrument on the vessel, portable memory devices and laptop or other computers via LAN, wireless, internet, National Electrical Manufacturers Association (NEMA) protocol, proprietary protocol or other suitable communication protocol.

The load cell 106 includes a body 110 having at least one mounting feature 112 and a load attaching feature 114. Components of the load cell 106 are in phantom in FIG. 2, and may include a power source 120, a switch 122 and a stain gage circuit 124. The power source 120, such as at least one of a battery, solar cell or other suitable power source, is disposed in the body 110 and is for operating the load cell 106. The switch 122 may be utilized to operably connect the power source 120 to the communication feature 108. The stain gage circuit 124 is embedded in the body 110, as conventionally known in load cell technology. The stain gage circuit 124 provides a metric indicative to force, such as the weight of an object suspended from the load cell 106, which may be communicated through the communication feature 108 to the marine electronic instrument 102. It is contemplated that other circuitry may be developed which may be utilized to providing the metric indicative to force to the communication feature 108. The communication feature 108 may be coupled to, or embedded in, the body 110.

The body 110 of the load cell 106 may also include a memory 126. The memory 126 may be utilized to store calibration information. This allows the load cell 106 to be remotely calibrated from the marine electronic instrument 102, while allowing the marine electronic instrument 102 to provide a certified read-out of the weight.

The load attaching feature 114 may be a hole to allow a shackle, hook, line or other feature which allows a fish to be suspended from the load cell 106 for weighing. The mounting feature 112 may be a hole for securing the body 110 to the vessel 100 such that the load cell 106 may be suspended from the vessel or other object, or at least oriented such that a load may be suspended from the load cell 106. In one embodiment, the mounting feature 112 includes a shackle, carbineer, lanyard or strap suitable for hanging the load cell 106 to a vessel structure, such as a portion of a tower, t-top, radar arch and the like. It is also contemplated that the load cell 106 may be suspended by hand or from another object, for example, from a piling of a pier, or other suitable object. This allows the load cell 106 to be mounted to the vessel 100, when needed, such as for weighing a fish, and to be easily taken down when not in use to prevent a crew member or passenger from inadvertently hitting their head on the hanging load cell 106. Since the load cell 106 is not permanently attached to the vessel 106, the load cell 106 may be sent out for calibration without the marine electronic instrument 102 being removed from the vessel 106, thereby allowing the use of the other features of the marine electronic instrument 102, such as navigation, radar, sounding, and the like, while the load cell 106 is not on board the vessel 106.

The marine electronic instrument 102 is configured to interface with the load cell 106 such that the weight of the fish (or other object) being weighed may be stored in the memory 140 of the marine electronic instrument 102, for displaying on the marine electronic instrument 102, recording in memory 140, or transmission to another electronic device other than the load cell 106. In one embodiment, the marine electronic instrument 102 may be set to a mode which receives a signal from the load cell 106 and converts the signal into weight information. The weight information may be displayed on a display of the marine electronic instrument 102 and/or recorded into memory of the marine electronic instrument 102.

Other information may be associated with the weight information in the memory of the marine electronic instrument 102. Such associated information may include information available to, stored on and/or generated by the marine electronic instrument 102. In one embodiment, calibration information obtained from the memory 120 of the load cell 106 may be associated with the weight information so that on-vessel weigh system 130 functions as a certified scale.

In one embodiment, the associated information may be information manual keyed into the marine electronic instrument 102 by the user and associated with the weigh information. Manual information may include the angler's personal information (gender, age, name, residence), type of fish, method used to catch the fish, line test information, or other information.

In another embodiment, the marine electronic instrument 102 may be configured to associate the weight information with automatically retrieved information. Automatically retrieved information is information available electronically to (or produced by) the marine electronic instrument 102, such as location (lat/lon), date, time, water depth, and water temperature, among other information.

In another embodiment, associated information may include information retrieved electronically from another device, such as an optical device 150, for example, a camera, video recorder, cell phone or other image capturing device, thereby enabling a picture of the angler and/or fish to be recorded in memory along with the weight and other selected information. For example, a cell phone may send a picture of the angler and fish via Bluetooth, text message, electronic mail or other communication protocol to the marine electronic instrument 102 where it may be associated with the weight information.

Optionally, the marine electronic instrument 102 may be configured to communicate the weight information and optionally the associated information to a remote device, such as a cell phone, laptop or other computer, printer, camera or other device. Such communication may be made, for example, via hardwire or wireless means, such as by Bluetooth, text message, electronic mail, instant message, or other communication protocol, between the marine electronic instrument 102 and the remote device. Communication made by the marine electronic instrument 102 may also be made through the use of a removable memory device, such as a flash drive. The marine electronic instrument 102 may communicate with weight information and optionally the associated information via wireless or cable such that the weight information and/or optional associated information may be printed, made into a photo, sent to another party, stored in a memory device unassociated with the vessel or utilized for other purposes.

In operation, the load cell 106 is coupled to the vessel 100 when needed and powered on utilizing the switch 122. The marine electronic instrument 102 may automatically detect that the load cell 106 is one, or the marine electronic instrument 102 may need to be prompted by the user to establish communication with the load cell 106. A fish is suspended from the load cell 106 and a signal is communicated from the load cell 105 to the marine electronic instrument 102 indicative of the weight of the fish. The marine electronic instrument 102 displays the weight of the fish, and may be prompted to store the weight information into memory. Additionally information, either manual and/or automatic, may be associated with the weight information. After weighing, the fish may be release unharmed, if desired. Advantageously, since the load cell may be calibrated and certified prior to the use on the vessel, fish of record weight may be weighed using a certified scale on the vessel 100 (e.g., the load cell 106 of the on-vessel weigh system 130) without need to potentially kill the fish while bringing the fish ashore to be weighed on a certified scale. After use, the load cell 106 may be taken down and stored out of the way.

Although various embodiments which incorporate the teachings of the present invention have been shown and described in detail herein, those skilled in the art can readily devise many other varied embodiment that still incorporate these teachings.

What is claimed is:

1. An on-vessel weight system comprising:
a marine electronic instrument; and
a load cell having a communication feature operable to provide a signal indicative of a weight measured by the load cell to the marine electronic instrument.

2. The on-vessel weigh system of claim 1, wherein the marine electronic instrument is at least one of a depth sounder, fish finder, loran, global positioning system (GPS), chart plotter or radar.

3. The on-vessel weigh system of claim 2, wherein the communication feature of the load cell is operable to communicate wirelessly with the marine electronic instrument.

4. The on-vessel weigh system of claim 2, wherein the communication feature of the load cell is operable to communicate wirelessly with the marine electronic instrument by at least one of a radio frequency communication protocol, a microwave communication protocol, an infrared (IR) communication protocol, standard IEEE 802.11 protocol, or a Bluetooth protocol.

5. The on-vessel weigh system of claim 2, wherein the load cell further comprises:
a body having at least one mounting feature and a load attaching feature, the at least one mounting feature suitable for suspending the body from an object.

6. The on-vessel weigh system of claim 5, wherein the load cell further comprises:
a power source; and
a switch operably coupling the power source to the communication feature.

7. The on-vessel weigh system of claim 5, wherein the power source of the load cell further comprises:
at least one of a battery or solar cell.

8. An on-vessel weight system for use in a recreational fishing vessel, comprising:
a marine electronic instrument selected from the group consisting of a depth sounder, fish finder, loran, global positioning system (GPS), chart plotter, radar and combinations thereof, the marine electronic instrument having communication feature and mountable to the recreational fishing vessel; and
a portable load cell comprising:
a body having at least one mounting feature and a load attaching feature, the at least one mounting feature suitable for suspending the body from an object;
a communication feature operable to provide a signal indicative of a weight suspended from the load cell to the marine electronic instrument;
a power source; and
a switch coupled to the body operably coupling the power source to the communication feature.

9. The on-vessel weigh system of claim 8, wherein the communication feature of the load cell is operable to communicate wirelessly with the marine electronic instrument.

10. A method for recording weight of a fish, comprising:
on a marine electronic instrument, storing to memory weigh information in response to receiving a signal indicative of a weight of a fish suspended from a load cell, wherein the marine electronic instrument is or is in communication with at least one of a depth sounder, fish finder, loran, global positioning system (GPS), chart plotter or radar.

11. The method of claim 10 further comprising:
displaying the weigh information on the display of the marine electronic instrument.

12. The method of claim 10 further comprising:
storing in the marine electronic instrument additional information associated with the weigh information.

13. The method of claim 12, wherein storing additional information associated with the weigh information further comprises:
automatically associating information obtained from the marine electronic information instrument or a second marine electronic information instrument in communication with the marine electronic information instrument in communication with the load cell.

14. The method of claim 12, wherein associating additional information further comprises:
associating information obtained manually keyed into the marine electronic information instrument.

15. The method of claim 13, wherein associating additional information further comprises:
associating calibration information.

16. The method of claim 10 further comprising:
transmitting the weigh information to an electronic device other than the load cell.

17. The method of claim 16 further comprising:
transmitting information associated with the weigh information to the electronic device other than the load cell.

18. The method of claim 10 further comprising:
storing an image in the memory; and
associating the image with the weight information.
